(19) United States
(12) Patent Application Publication
(10) Pub. No.: US 2013/0195019 A1
(43) Pub. Date: Aug. 1, 2013

(54) INITIAL ACCESS IN CELLS WITHOUT COMMON REFERENCE SIGNALS

(71) Applicants: Lars E. Lindh, Helsingfors (FI); Klaus Hugl, Vienna (AT); Frank Frederiksen, Klarup (DK)

(72) Inventors: Lars E. Lindh, Helsingfors (FI); Klaus Hugl, Vienna (AT); Frank Frederiksen, Klarup (DK)

(73) Assignee: Nokia Corporation

(21) Appl. No.: 13/359,864

(22) Filed: Jan. 27, 2012

(51) Int. Cl. H04W 72/04

(52) U.S. Cl. 370/329

(57) ABSTRACT

Frequency resources for common control regions of a control channel are defined or determined as a function of at least bandwidth and an identifier of a specific cell. Communications between a wireless network and a mobile device are then done using the defined/determined frequency resources of the common control regions of the control channel. In the non-limiting embodiments: the bandwidth is bandwidth of a cell or of a component carrier; the frequency resources are defined/determined further as a function of an offset value; the common control regions are of an ePDCCH and the offset value differs from a channel edge offset value for common control regions of all other ePDCCHs of all other adjacent cells or all other transmit nodes in the same cell; and the frequency resources comprise frequency stripes (which may be interleaved by resource element groups) distributed in frequency across the bandwidth.

### TECHNICAL FIELD

poll This invention relates generally to radio frequency (RF) reception and transmission and, more specifically, relates to downlink control channels such as for example the enhanced PDCCH (E-PDCCH) in the LTE system.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

CCE control channel element

CRS common reference signal

CSI channel state information

DL downlink (network towards UE)

DM-RS demodulation reference signal

eNB EUTRAN Node B (a BS in the LTE system)

ePDCCH enhanced PDCCH

E-UTRAN evolved UTRAN (LTE)

FDM frequency division multiplexing

LTE long term evolution

MIB master information block

MIMO multiple input multiple output

MME mobility management entity

PBCH physical broadcast channel

PDCCH physical downlink control channel

PDSCH physical downlink shared channel

PHICH physical hybrid indicator channel

PRB physical resource block

PSS/SSS primary/secondary synchronization signal

PUSCH physical uplink shared channel

RAN radio access network

RF radio frequency

RE resource element

REG resource element group

RS reference signal

SI/SIB system information/system information block

TDM time division multiplexing

UE user equipment

UL uplink (UE towards network)

UTRAN universal terrestrial radio access network

Further developments of the LTE system intend for its next release (Release 11) an enhanced downlink control channel concept referred to as ePDCCH. Early studies in the 3GPP have been carried out as part of the “Enhanced DL MIMO Study item”, and during the December 2011 radio access network RAN plenary meeting a work item in which this ePDCCH will be specified has been agreed.

One feature of this new control channel is that it shall operate with DM-RS reference symbols for the demodulation. Note that this feature has already been implemented for some configurations of the data-bearing PDSCH channel. The benefits of the ePDCCH is that it can utilize frequency domain packet scheduling (FDPS) gain and beamforming by using localized resources for the control channel. It is anticipated that for at least early adoptions the ePDCCH could use the legacy PDCCH for transmitting common control signals such as system information (SI), random access channel (RACH) response indicator and paging indicator.

It has also been discussed in the 3GPP whether the ePDCCH should contain distributed control resources for UEs for which there is no CSI available or for common control transmitted to all UEs. One of the future targets with ePDCCH is that it could also potentially be used in CRS-less cells, where the legacy PDCCH cannot operate. A decision was made in October 2011 at a 3GPP RANI meeting to specify a “new carrier type” as part of the 3GPP RAN work item concerning Carrier Aggregation Enhancements. The possible standalone operation in a CRS-less cell as a future feature requires much more refinement for the common control before such a standalone ePDCCH could be deployed in a practical wireless system.

To better appreciate the issues involved, some of the processes and signaling involved when a UE first joins a cell are now summarized. Its first task is the initial access, which in the LTE Release Aug. 9, 2010 versions includes the following steps:
The UE listens to signals from different cells and select the one with the best channel characteristics. Thereby, the UE listens to the synchronization channels PSS/SSS of the cells and obtains time synchronization. CRS reference signals can improve the result of this (with respect to the required synchronization time as well as increasing the probability of successful synchronization as such).
The UE reads the Physical Broadcast Channel PBCH of the selected cell and obtains some basic information as the bandwidth, number of active transmit antennas and the number of PHICH resources. CRS reference signals are needed for this.
The UE reads the legacy control channel PDCCH and waits for a subframe where the control channel defining the system information block (SIB) is transmitted. CRS over the whole bandwidth is always needed for the decoding of the PDCCH, as for Release 8-10 this signaling channel is distributed/interleaved over the full channel bandwidth.
The UE reads the SIB, which is repeated over several subframes for better reliability.

After all these steps the UE is finally able to access the cell. The problem is that the above procedure does not work in a cell without a fall bandwidth CRS because the PDCCH for such cases cannot be demodulated and detected. This is because the PDCCH requires a full-bandwidth CRS, and the ePDCCH must first be configured to the UE in order for the UE to be able to decode it.

### BRIEF DESCRIPTION OF THE DRAWINGS

FIG. 1 is a frequency diagram showing a common control ePDCCH region for two neighbor cells, containing frequency resources in those ePDCCHs for common and UE-specific control according to an exemplary embodiment of these teachings.

FIG. 2 is a logic flow diagram that illustrates from the perspective of a network access node and of a user device the operation of a method, and a result of execution by an apparatus of a set of computer program instructions embodied on a computer readable memory, in accordance with the exemplary embodiments of this invention.

FIG. 3 is a simplified block diagram of a user equipment and an E-UTRAN eNB access node which are exemplary devices suitable for use in practicing the exemplary embodiments of the invention.

### SUMMARY

In a first exemplary aspect of the invention there is an apparatus which includes at least one processor and at least one memory including computer program code. The at least one memory and the computer program code are configured to, with the at least one processor and in response to execution of the computer program code, cause the apparatus to perform at least the following: determine frequency resources for common control regions of a control channel as a function of at least bandwidth and an identifier of a specific cell; and control a transmitter or a receiver to communicate between a wireless network and a mobile device using the defined frequency resources of the common control regions of the control channel.

In a second exemplary aspect of the invention there is a method which includes the following: determining frequency resources for common control regions of a control channel as a function of at least bandwidth and an identifier of a specific cell; and controlling a transmitter or a receiver to communicate between a wireless network and a mobile device using the defined frequency resources of the common control regions of the control channel.

In a third exemplary aspect of the invention there is a computer readable memory storing a program of instructions comprising: code for determining frequency resources for common control regions of a control channel as a function of at least bandwidth and an identifier of a specific cell; and code for controlling a transmitter or a receiver to communicate between a wireless network and a mobile device using the defined frequency resources of the common control regions of the control channel.

In a fourth exemplary aspect of the invention there is an apparatus which includes determining means and controlling means. The determining means is for determining frequency resources for common control regions of a control channel as a function of at least bandwidth and an identifier of a specific cell. The controlling means is for controlling a transmitter or a receiver to communicate between a wireless network and a mobile device using the determined frequency resources of the common control regions of the control channel. In a particular embodiment the means for determining and the means for controlling comprise at least one processor executing a program of instructions stored on a computer readable memory. Such an apparatus according to this fourth aspect may be an access node of the wireless network or the mobile device, in which case the apparatus will also include the transmitter or receiver. In other embodiments the apparatus may be only one or more components configured for use in such an access node or mobile device.

### DETAILED DESCRIPTION

Embodiments of these teachings provide a control channel such as the ePDCCH which contains UE-specific as well as common control resources. By example the common control resources will be used for the network to send system information, for a random access channel on which UEs can first obtain a connection with the cell, and for paging UEs. Especially in PDCCH-less primary (PCell) and stand-alone carriers the system information (SI) in the common ePDCCH control resources is expected to be the only source where the initial cell specific parameters can be signaled by the network.

In current 3GPP discussions the ePDCCH is to be multiplexed with PDSCH in the frequency domain, meaning control information and data will be multiplexed together. This suggests that some of the PRB pairs will be reserved for the ePDCCH.

Additionally, it is preferable that the frequency resources for the UE-specific and for the common control will be non-overlapping, since the common control should be transmitted in a frequency distributed way in order to utilize frequency diversity and to ensure the correct reception by multiple UEs covering the entirety of a cell area. Further, it is desirable that the network have the option of providing different offsets for different cells in the system to allow for some kind of interference management between neighboring cells.

Embodiments of these teachings solve this problem by explicitly or implicitly (or a combination of both) conclude the frequency resources for the common control from the configured system bandwidth and the cell identifier. If the common control region of the ePDCCH is operational and the UE has read the SIB, the cell specific control resources are known by the UE, and further the UE-specific control parameters can in addition be signaled by the network.

The size of the resources for common control in the ePDCCH does not need to be very large in most cases. For example, in LTE Release Aug. 9, 2010 the common control region of the PDCCH is only 16 CCEs, which corresponds to 36*16=576 resource elements. For a CRS-less component carrier this would be about four physical resource blocks. One physical resource block is also known in LTE as a PRB pair. If also the physical hybrid indicator channel (PHICH, or more precisely ePHICH) is included in these common control frequency resources, the total amount of resources for common control would be correspondingly larger.

While in general there is an algorithm or function which derives the frequency resources for the common control region from the component carrier bandwidth and the cell ID, various specific embodiments also take into consideration the following non-limiting aspects. In a first embodiment the size of the resources for common control is a function of the bandwidth. In a second embodiment the PHICH resources are taken into account when defining the common control resource size. In a third embodiment the position of the common control is enforced to be in different PRBs for neighbor cells so that they do not overlap in frequency among adjacent cells, in order to mitigate interference via inter-cell coordination. In a fourth embodiment the PRB pairs used for the common control are distributed in frequency. For best performance the control resources can be interleaved on a REG basis inside the distributed resource pool (in conventional LTE there are 4 REs per REG).

In a fifth embodiment the cell is split into several transmission nodes, where each node uses different control regions even if the CellID is the same for all nodes.

In one embodiment, where the regions for control and data resources are defined by frequency division multiplexing (FDM) the common control region is defined by clusters of n consecutive PRB pairs, which are spanning all or most of the OFDM symbols in the subframe and where is n is a small number. These clusters are here referred to as stripes. In this embodiment the UE needs at least part of the following parameters to define the common control resources:
Number of frequency stripes
Number of PRB pairs in a frequency stripe
Distance between the frequency stripes (could be basically derived from the bandwidth)
Offset from channel edge for the first stripe

Because there are a limited number of PRBs in the smaller bandwidth of the component carriers which carry the ePDCCH (particularly stand-alone ePDCCHs), there will only be slight variations to the first two of those parameters listed above. The distance between the frequency stripes has strong variations and is very much depending on the system bandwidth, since in exemplary embodiments the frequency distributed transmission should cover the overall available bandwidth as much as possible. The frequency offset can have a larger variation and so it is also the parameter that is used to create non-overlapping common control resources in neighbor cells.

All the above embodiments are an efficient use of the spectrum because there is no waste of control resources. Namely, UE specific control can be for some downlink control information DCI format also transmitted in the common control resources, as is possible with the legacy PDCCH in current LTE specifications.

In a particular embodiment the formula or algorithm which the UE uses for determining the common control region can be a many-to-many type of mapping from the bandwidth, the cell ID, and a potential signaled shift to a small set of value candidates (such as the offset values), which the UE can blindly test with a reasonable number of blind decodings.

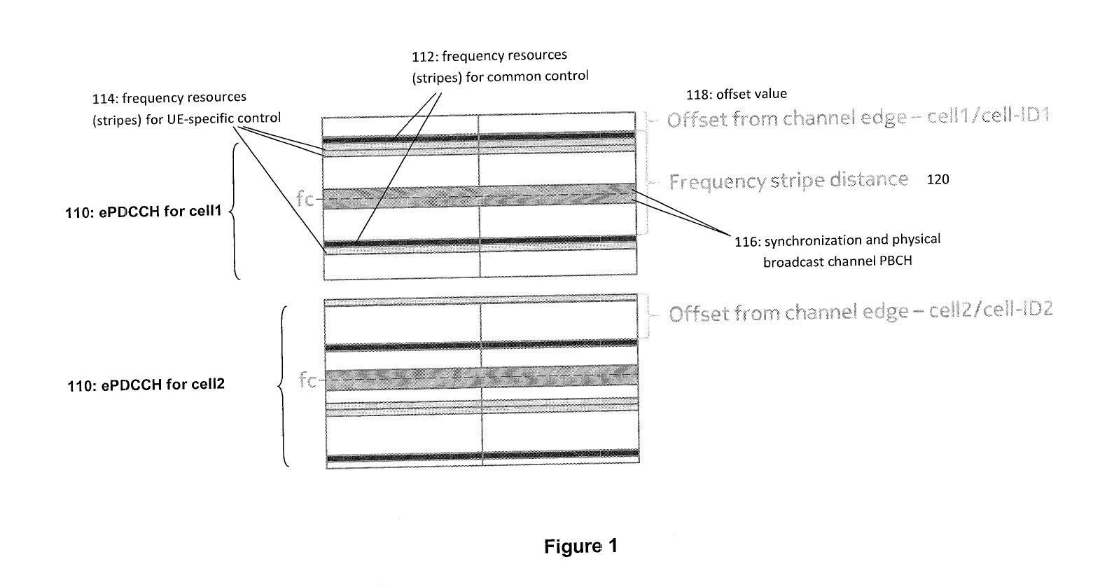

In one exemplary embodiment the shift value is signaled by being embedded into the eNB's transmission of the master information block MIB, which is broadcast on the synchronization and physical broadcast channel PBCH in legacy LTE systems and which is shown in FIG. 1 as straddling the center frequency f_{c} of the bandwidth in which the ePDCCH lies. Such shift values may be placed in any of the reserved (spare) resources on this common transmission channel. With such a shift value added to the signaling, it would be possible to do a further offset of the common control search space. Note that this shift value could be omitted, such in the case where the common control resources of adjacent eNBs are orthogonal to one another. In one embodiment this “shift” value which is signaled on the MIB is interpreted by the UE as an indication of the size of the common search space for the ePDCCH. In the following equation that term shift is at the right side of the equation. The UE's stored algorithm/function at the right side of that equation is used to resolve by blind decoding which of the values (vectors which represent different common control region configurations which the UE tests until it finds the channel) at the left side of the equation is the valid configuration for the ePDCCH:

{value_{—}1, value_{—}2 . . . value_n }=f(BW,CellID,shift)

It is within these teachings that the above equation is deterministic for a single configuration of the common control regions of the ePDCCH from the cell or component carrier bandwidth and the cell-ID, as well as a potential signaled shift that is provided within the MIB.

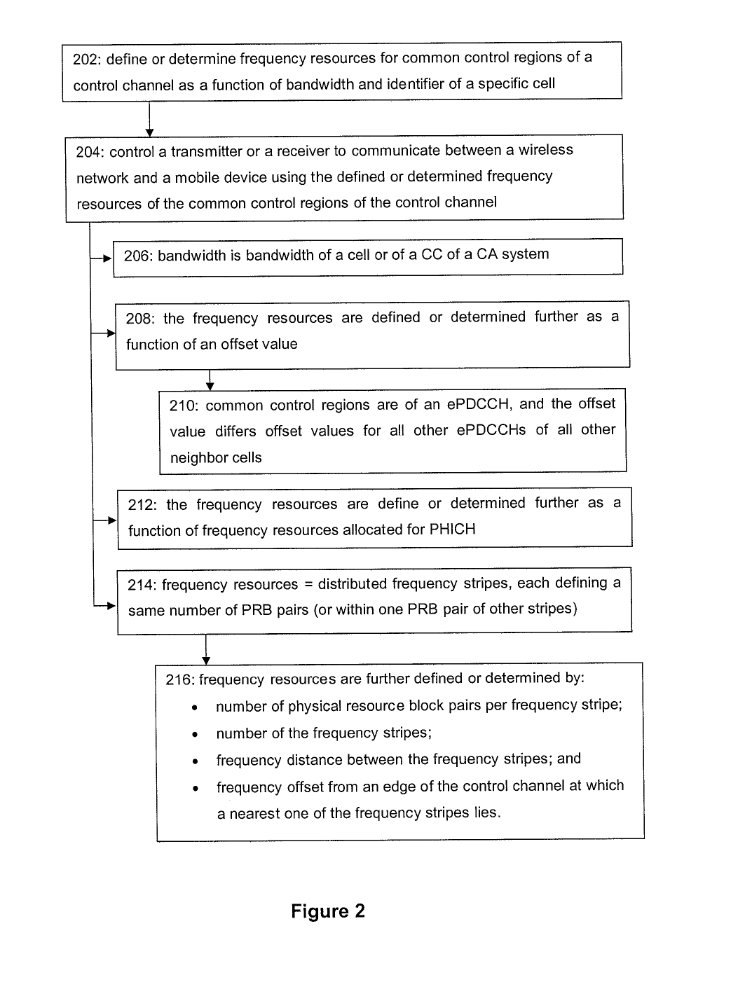

The above exemplary embodiments are summarized with reference to FIGS. 1 and 2. FIG. 1 illustrates two frequency diagrams of the ePDCCH for two neighboring (geographically adjacent, but same carrier frequency fc) cells, with frequency along the vertical axes. Each of those two cells has different CellIDs. The cells may be under different eNBs, or they may be different cells/sectors under the same physical eNB but with different CellIDs. These diagrams show the frequency resources for common control in dark shading, the frequency resources for UE-specific control in lighter shading. This example has frequency distribution per ePDCCH among two frequency stripes used for common control but this is a non-limiting example; other functions according to these teachings may define for a given ePDCCH more than only two frequency stripes.

The shading which is centered on and which includes the center frequency f_{c} of the ePDCCH is used for the PSS/SSS and PBCH on which the UE's seeking initial access to the cell may obtain the MIB. From decoding that MIB the UE will learn the bandwidth of the cell and the cellID. In some deployments of LTE Release 11 it may be adopted that when the cell bandwidth is below a certain threshold that cell will utilize an ePDCCH but no PDCCH, and so from the bandwidth information the UE will know to use the algorithm/function it has stored in its local memory in order to define where are the frequency resources for the common control in the ePDCCH. In one embodiment there are a number of such algorithms/functions (or different adaptations to some base algorithm) that are pre-configured for the UE, and the eNB indicates to the UE (such as in the MIB) which one to use in a given situation. In any case both the eNB and the UE have a common understanding of how to define the common regions of the ePDCCH. The bandwidth & CellID could define number of frequency stripes, offset etc. by such algorithms/functions so with proper network planning, choosing the CellID should in most cases be enough to avoid having that additional signaling above in the In other embodiments the MIB will indicate directly that the carrier is using ePDCCH without any PDCCH since the MIB and the PBCH are assumed to be always available. In another embodiment, the MIB content will indicate the combined resources for common control in ePDCCH. Any of these mentioned embodiments implies the carrier does not use CRSs.

Block 202 of FIG. 2 summarizes the above function in which frequency resources for common control regions of a control channel are determined as a function of at least bandwidth and identifier of a specific cell. Such identifiers are shown at FIG. 1 as Cell-ID 1 and Cell-ID2. The UE seeking initial access to the cell will use the function to determine where are the common control regions so it can secure its initial access. The network will use the same function to define the common control regions for the cell since it will be using the same function. By example, each the eNB and the UE will have this function stored in their local memory, but the function itself may be published in a wireless standard to assure that all participating radio entities use the same function.

Block 204 of FIG. 2 states the positive action of controlling a transmitter (in the case of the network/eNB) or a receiver (in the case of a UE) to communicate between a wireless network and a mobile device (such as the UE) using the defined or determined frequency resources of the common control regions of the control channel. Such common control regions 112 are annotated in FIG. 1 for the ePDCCH 110 for Cell1 and shown by darkened shading for cell2. The common control regions 112 are frequency resources due to the vertical axis of FIG. 1 being frequency of the channel ePDCCH. This positive action may include the actual transmitting and receiving, or it may be outputting to a transmitter or receiver a control signal, as would be the case when one or more components of the eNB or UE (which do not themselves include a transmitter or receiver) execute block 202 of FIG. 2 as opposed to the entire eNB/UE.

Further portions of FIG. 2 illustrate different ones of the above exemplary but non-limiting embodiments. Block 206 specifies that the bandwidth noted at block 202 is bandwidth of a cell (such as a stand-alone carrier) or of a component carrier of a carrier aggregation system. Block 208 details that the frequency resources for common control regions 112 of the control channel first stated at Mock are defined further as a function of an offset value 118. That offset value may in some embodiments be communicated between the wireless network (eNB) and the mobile device (UE) such as in a master information block on a broadcast channel PBCH 116 (or on some other broadcast channel as the MIB may be sent in some other broadcast channel in future iterations of LTE and other radio access technologies), and in other embodiments the offset value itself may be a function of the bandwidth and identifier of a specific cell (CellID) in which case it need not be signaled directly. And block 210 of FIG. 2 details particularly that the common control regions are of an ePDCCH 110, and the offset value of block 208 differs from a channel edge offset value for common control regions of all other ePDCCHs of all other adjacent cells. This difference is visible at FIG. 1 in the offsets between cell1 and cell2. Different offset values may also be used to separate the ePDCCH common control regions for other transmission nodes in the same cell. For example, multiple network transmitting nodes may be operating in the same cell for cooperative multipoint transmissions, where there might be a macro eNB and one or more pico eNBs or remote radio heads inside the same cell.

Block 212 details an embodiment above in which the frequency resources for common control regions 112 of the control channel 110 are defined or determined further as a function of frequency resources allocated for a physical hybrid indicator channel PHICH.

Block 214 details another specific embodiment in which the frequency resources comprise frequency stripes which are distributed in frequency across the bandwidth, as shown for each ePDCCH 110, 120 at FIG. 1. Each stripe defines the same number of PRB pairs, and in the example noted above each stripe consisted of only one PRB pair. In some implementations there may not be sufficient room for the last of the frequency stripes to have the same number of PRB pairs, leading to one less PRB pair in that last stripe as compared to all the other frequency stripes. In this case each stripe will have either x or x+1 PRB pairs, where x is an integer at least equal to one. Another more specific example above is that each of those frequency stripes is interleaved in a resource element group. Block 216 adds further detail to the embodiment of block 214 in that the frequency resources of block 202 are defined or determined further using values for: the number of physical resource block pairs per frequency stripe; a number of the frequency stripes; a frequency distance 120 between the frequency stripes; and a frequency offset 118 from an edge of the control channel 110 at which a nearest one of the frequency stripes lies. In one embodiment these values are communicated between the wireless network (eNB) and the mobile device (UE), and in another embodiment these values are fixed and need not be signaled (e.g., hardcoded in the memory of the eNB and the UE, and depending on the bandwidth and the CellID). Above it was detailed that in some embodiments the offset can be found from bandwidth and cellID, and the frequency stripes are spaced as a function of how many and the bandwidth, in which case only the first two bulleted items in block 216 need to be signaled or pre-configured (fixed) for the eNB and UE to know (in addition to the bandwidth and identifier at block 202) exactly where are the common control regions.

For the case in which the process of FIG. 2 is performed by a network access node of the wireless network (such as an eNB but known by other terminology in other radio access technologies), such an access node is configured to transmit common control information in the frequency resources it defines for the common control regions of the control channel to mobile devices in the cell.

For the case in which the process of FIG. 2 is performed by the mobile device stated at block 204, such a mobile device is configured to receive from the wireless network common control information in the determined frequency resources for the common control regions of the control channel, and the mobile device is further configured to receive user-equipment specific control information in other frequency resources (shown in FIG. 1 as the UE-specific control 114) of the control channel 110 which are distinct from the determined frequency resources for common control 112.

The logic flow diagram of FIG. 2 summarizes the various exemplary embodiments of the invention from the perspective of the network or from the UE (or certain components thereof if not performed by the entire eNB or UE), and may be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

The various blocks shown at FIG. 2 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Certain of the exemplary embodiments of these teachings provide the following technical effects and advantages. They enable CRS-less initial cell access by a UE, and can be adopted using only existing channels for future advances of the LTE system. There is no additional signaling overhead in some embodiments as the offset may be implicitly defined as a function of the bandwidth and the CellID rather than signaled in the MIB directly, and the function used to define the common control regions is adaptable to different bandwidths. These teachings assure a robust operation because the common control resources 112 are in a known position. Adoption of these teachings will not adversely affect enhanced inter-cell interference coordination. And finally there is no waste of radio resources because the UE-specific control can, for at least some DCI formats, be transmitted in the common control resources in a manner that is already done for legacy PDCCH.

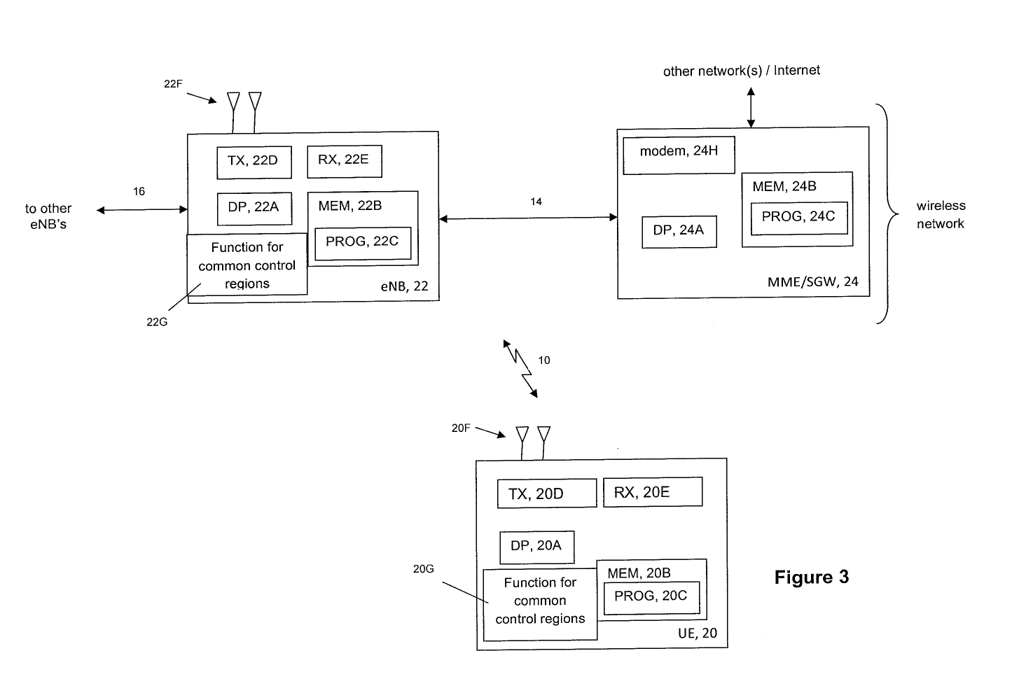

Reference is now made to FIG. 3 for illustrating a simplified block diagram of various electronic devices and apparatus that are suitable for use in practicing the exemplary embodiments of this invention. In FIG. 3 an eNB 22 is adapted for communication over a wireless link 10 with an apparatus, such as a mobile device/terminal such as a UE 20 While there are typically several UEs under control of the eNB 22, for simplicity only one UE 20 is shown at FIG. 3. The eNB 22 may be any access node (including frequency selective repeaters) of any wireless network such as LTE, LTE-A, GSM, GERAN, WCDMA, and the like. The operator network of which the eNB 22 is a part may also include a network control element such as a mobility management entity MME and/or serving gateway SGW 24 or radio network controller RNC which provides connectivity with further networks (e.g., a publicly switched telephone network and/or a data communications network/Internet).

The UE 20 includes processing means such as at least one data processor (DP) 20A, storing means such as at least one computer-readable memory (MEM) 20B storing at least one computer program (PROG) 20C or other set of executable instructions, communicating means such as a transmitter TX 20D and a receiver RX 20E for bidirectional wireless communications with the eNB 22 via one or more antennas 20F. Also stored in the MEM 20B at reference number 20G is the UE's algorithm or function for defining the common control regions of the control channel/ePDCCH as detailed further above. From knowing these control regions the DP 20A can then know the tuning command with which to control the receiver 10E to tune to the correct frequency.

The eNB 22 also includes processing means such as at least one data processor (DP) 22A, storing means such as at least one computer-readable memory (MEM) 22B storing at least one computer program (PROG) 22C or other set of executable instructions, and communicating means such as a transmitter TX 22D and a receiver RX 22E for bidirectional wireless communications with the UE 20 (or UEs) via one or more antennas 22F. The eNB 22 stores at block 22G the algorithm or function for defining the common control regions of the control channel/ePDCCH as detailed in the various embodiments above. From knowing these control regions the DP 20A can then know the tuning command with which to control the transmitter 22D to tune to the correct frequency and send the common control information cell-wide.

At least one of the PROGs 22C/22G in the eNB 22 is assumed to include a set of program instructions that, when executed by the associated DP 22A, enable the device to operate in accordance with the exemplary embodiments of this invention, as detailed above. The UE 20 also stores software 20C/20G in its MEM 20B to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 3 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other types of wireless communication systems.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising
at least one processor; and
at least one memory including computer program code;
in which the at least one memory and the computer program code is configured, with the at least one processor, to cause the apparatus at least to:
define or determine frequency resources for common control regions of a control channel as a function of at least bandwidth and an identifier of a specific cell; and
control a transmitter or a receiver to communicate between a wireless network and a mobile device using the defined or determined frequency resources of the common control regions of the control channel.

2. The apparatus according to claim 1, wherein the bandwidth is bandwidth of a cell or of a component carrier of a carrier aggregation system.

3. The apparatus according to claim 1, in which the frequency resources for common control regions of the control channel are defined or determined further as a function of an offset value.

4. The apparatus according to claim 3, in which the common control regions are of an ePDCCH, and the said offset value differs from a channel edge offset value for common control regions of all other ePDCCHs of all other adjacent cells or other transmission nodes inside the same cell.

5. The apparatus according to claim 1, in which the frequency resources for common control regions of the control channel are defined or determined further as a function of frequency resources allocated for a physical hybrid indicator channel PHICH.

6. The apparatus according to claim 1, in which the frequency resources comprise frequency stripes distributed in frequency across the bandwidth, each stripe defining a number x or x+1 of physical resource block pairs, in which x is an integer at least equal to one.

7. The apparatus according to claim 6, in which each frequency stripe is interleaved in a resource element group.

8. The apparatus according to claim 6, in which the frequency resources are defined or determined further using values for at least:
the number of physical resource block pairs per frequency stripe; and
a number of the frequency stripes.

9. The apparatus according to claim 1, in which the apparatus comprises a network access node of the wireless network which is configured to transmit common control information in the defined frequency resources for the common control regions of the control channel.

10. The apparatus according to claim 1, in which the apparatus comprises the mobile device which is configured to receive from the wireless network common control information in the determined frequency resources for the common control regions of the control channel, and which is further configured to receive user-equipment specific control information in other frequency resources of the control channel which are distinct from the said determined frequency resources.

11. A method comprising:
defining or determining frequency resources for common control regions of a control channel as a function of at least bandwidth and an identifier of a specific cell; and controlling a transmitter or a receiver to communicate between a wireless network and a mobile device using the defined or determined frequency resources of the common control regions of the control channel.

12. The method according to claim 11, wherein the bandwidth is bandwidth of a cell or of a component carrier of a carrier aggregation system.

13. The method according to claim 11, in which the frequency resources for common control regions of the control channel are determined further as a function of an offset value.

14. The method according to claim 13, in which the common control regions are of an ePDCCH, and the said offset value differs from a channel edge offset value for common control regions of all other ePDCCHs of all other adjacent cells or other transmission nodes inside the same cell.

15. The method according to claim 11, in which the frequency resources for common control regions of the control channel are defined or determined further as a function of frequency resources allocated for a physical hybrid indicator channel PHICH.

16. The method according to claim 11, in which the frequency resources comprise frequency stripes distributed in frequency across the bandwidth, each stripe defining a number x or x+1 physical resource block pairs, in which x is an integer at least equal to one.

17. The method according to claim 16, in which each frequency stripe is interleaved in a resource element group.

18. A computer readable memory storing a program of instructions comprising:
code for defining or determining frequency resources for common control regions of a control channel as a function of at least bandwidth and an identifier of a specific cell; and
code for controlling a transmitter or a receiver to communicate between a wireless network and a mobile device using the defined or determined frequency resources of the common control regions of the control channel.

19. The computer readable memory according to claim 18, in which the frequency resources for common control regions of the control channel are defined or determined further as a function of an offset value.

20-21. (canceled)
